(19) United States
(12) Patent Application Publication
(10) Pub. No.: US 2021/0403768 A1
(43) Pub. Date: Dec. 30, 2021

(54) OPTICAL CLEAR ADHESIVE FILM

(71) Applicant: WUHAN CHINA STAR OPTOELECTRONICS TECHNOLOGY CO., LTD., Wuhan, Hubei (CN)

(72) Inventor: Feng DING, Wuhan, Hubei (CN)

(21) Appl. No.: 16/607,306

(22) PCT Filed: Jun. 3, 2019
(86) PCT No.: PCT/CN2019/089752

§ 371 Date: Oct. 22, 2019

(30) Foreign Application Priority Data
Apr. 28, 2019 (CN) 201910351388.2

(51) Int. Cl. C09J 7/40; C09J 7/10

(52) U.S. Cl. CPC C09J 7/403; C09J 7/10

(57) ABSTRACT

An optical clear adhesive film is provided. A first tearing part is disposed on a first side of a first protective film, such that when an external force is applied to the first tearing part, a starting position at which the colloid layer is separated from the first protective film is a line contact. Therefore, the colloidal layer is less stressed at each point of separation, and phenomenon that the colloid layer is pulled is avoided.

### FIELD OF INVENTION

The present disclosure relates to the field of adhesive material technologies, and more particularly to an optical clear adhesive film.

### BACKGROUND OF INVENTION

With maturity of flexible display panel technologies, mass production of flexible display panels has become possible, and the mass production of flexible display panels has laid a solid foundation for the manufacture of foldable display panels.

In module processes of foldable display panels, a bonding process is performed by an optical clear adhesive (OCA). In order to ensure foldable characteristics of the foldable panels, a thickness of the optical clear adhesive is generally thin. As illustrated in FIG. 1, a tearing position of a protective film 201 of a conventional optical clear adhesive is disposed at one corner of the protective film. When the protective film 201 is peeled off from a thin optical clear adhesive 200, removing the protective film from one corner may cause a “pull glue” phenomenon at a corner A of the optical clear adhesive.

Therefore, it is necessary to propose a technical solution to solve the issue that removing the protective film from one corner of the protective film tends to cause a pull glue phenomenon when a thickness of the optical clear adhesive is thin.

### SUMMARY OF INVENTION

An object of an embodiment of the present disclosure is to provide an optical clear adhesive, which can avoid a pull glue phenomenon of a colloidal layer when a protective film on at least one side of the colloid layer is peeled off from the optical clear adhesive film.

An embodiment of the present disclosure provides an optical clear adhesive film. The optical clear adhesive film includes a colloid layer, a first protective film, and a second protective film. The first protective film and the second protective film are attached to opposite sides of the colloid layer. The first protective film has a first body and a first tearing part, the first body has a first side, and the first tearing part extends from the first side. A thickness of the colloid layer ranges between 0.5 micrometers and 30 micrometers.

In an embodiment of the present disclosure, the first tearing part extends from an entire of the first side.

In an embodiment of the present disclosure, a number of the first tearing part is at least one, and a shape of the first tearing part is any one of an isosceles triangle, an isosceles trapezoid, a semi-ellipse shape, a semicircle, and a rectangle.

In an embodiment of the present disclosure, the first side has a plurality of line segments that are not connected to each other, and at least two of the line segments that are not connected to each other extend out of the first tearing part.

In an embodiment of the present disclosure, the first side includes a first line segment and a second line segment at opposite ends of the first side, the first side further includes a third line segment positioned in a middle of the first line segment and the second line segment, and the first line segment, the second line segment, and the third line segment each extend out of one of the first tearing part.

In an embodiment of the present disclosure, the second protective film has a second body and a second tearing part, the second body has a second side, and the second tearing part extends from the second side.

In an embodiment of the present disclosure, the second tearing part and the first tearing part are positioned on a same side of the optical clear adhesive film.

In an embodiment of the present disclosure, a vertical projection of the colloid layer on the first protective film is positioned in the first body, a vertical projection of the colloid layer on the second protective film is positioned in the second body, and a vertical projection of the first body on the second protective film overlaps with the second body.

In an embodiment of the present disclosure, a thickness of the colloid layer ranges between 1 micron and 25 microns.

In an embodiment of the present disclosure, a shape of the colloid layer is a rectangle having a connecting portion, the connecting portion is positioned at a corner of the rectangle, and the connecting portion is disposed on the colloid layer adjacent to a position of the first tearing part.

An embodiment of the present disclosure further provides an optical clear adhesive film. The optical clear adhesive film includes a colloid layer, a first protective film, and a second protective film. The first protective film and the second protective film are attached to opposite sides of the colloid layer. The first protective film has a first body and a first tearing part, the first body has a first side, and the first tearing part extends from the first side.

In an embodiment of the present disclosure, the first tearing part extends from an entire of the first side.

In an embodiment of the present disclosure, a number of the first tearing part is at least one, and a shape of the first tearing part is any one of an isosceles triangle, an isosceles trapezoid, a semi-ellipse shape, a semicircle, and a rectangle.

In an embodiment of the present disclosure, the first side has a plurality of line segments that are not connected to each other, and at least two of the line segments that are not connected to each other extend out of the first tearing part.

In an embodiment of the present disclosure, the first side includes a first line segment and a second line segment at opposite ends of the first side, the first side further includes a third line segment positioned in a middle of the first line segment and the second line segment, and the first line segment, the second line segment, and the third line segment each extend out of one of the first tearing part.

In an embodiment of the present disclosure, the second protective film has a second body and a second tearing part, the second body has a second side, and the second tearing part extends from the second side.

In an embodiment of the present disclosure, the second tearing part and the first tearing part are positioned on a same side of the optical clear adhesive film.

In an embodiment of the present disclosure, a vertical projection of the colloid layer on the first protective film is positioned in the first body, a vertical projection of the colloid layer on the second protective film is positioned in the second body, and a vertical projection of the first body on the second protective film overlaps with the second body.

In an embodiment of the present disclosure, a thickness of the colloid layer ranges between 1 micron and 25 microns.

In an embodiment of the present disclosure, a shape of the colloid layer is a rectangle having a connecting portion, the connecting portion is positioned at a corner of the rectangle, and the connecting portion is disposed on the colloid layer adjacent to a position of the first tearing part.

Beneficial effects of an embodiment of the present disclosure are that, the embodiment provides an optical clear adhesive film. A first tearing part is disposed on a first side of a first protective film, such that when an external force is applied to the first tearing part, a starting position at which the colloid layer is separated from the first protective film is a line contact. Therefore, the colloidal layer is less stressed at each point of separation, and phenomenon that the colloid layer is pulled is avoided.

### DESCRIPTION OF DRAWINGS

FIG. 1 is a schematic view illustrating a protective film peeled off from a corner of a colloid layer in the prior art.

FIG. 2 is a side view of an optical clear adhesive film according to a first embodiment of the present disclosure.

FIG. 3 is a first plan view illustrating a first protective film of the optical clear adhesive film as illustrated in FIG. 2.

FIG. 4 is a second plan view illustrating the first protective film of the optical clear adhesive film as illustrated in FIG. 2.

FIG. 5 is a third plan view illustrating the first protective film of the optical clear adhesive film as illustrated in FIG. 2.

FIG. 6 is a plan view of a colloid layer as illustrated in FIG. 2.

FIG. 7 is a side view of an optical clear adhesive film according to a second embodiment of the present disclosure.

FIG. 8 is a plan view illustrating a first protective film of the optical clear adhesive film as illustrated in FIG. 7.

FIG. 9 is a plan view illustrating a colloidal layer of the optical clear adhesive film as illustrated in FIG. 7.

FIG. 10 is a side view of an optical clear adhesive film according to a third embodiment of the present disclosure.

FIG. 11 is a top view of the optical clear adhesive film as illustrated in FIG. 10.

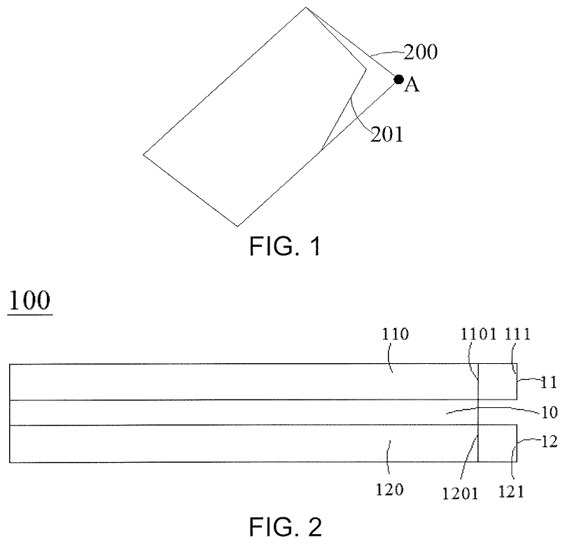

### DETAILED DESCRIPTION OF PREFERRED EMBODIMENTS

The technical solutions in the embodiments of the present disclosure will be clearly and completely described in the following with reference to the accompanying drawings in the embodiments. It is apparent that the described embodiments are only a part of the embodiments of the present disclosure, and not all of them. All other embodiments obtained by a person skilled in the art based on the embodiments of the present disclosure without creative efforts are within the scope of the present disclosure.

An embodiment of the present disclosure provides an optical clear adhesive film. The optical clear adhesive film includes a colloid layer, a first protective film, and a second protective film. The first protective film and the second protective film are attached to opposite sides of the colloid layer. The first protective film has a first body and a first tearing part, the first body has a first side, and the first tearing part extends from the first side.

A first tearing part is disposed on a first side of a first protective film, such that when an external force is applied to the first tearing part, a starting position at which the colloid layer is separated from the first protective film is a line contact. Therefore, the colloidal layer is less stressed at each point of separation, and phenomenon that the colloid layer is pulled is avoided.

The above technical solutions are described below in conjunction with specific embodiments.

Refer to FIG. 2, which is a side view of an optical clear adhesive film according to a first embodiment of the present disclosure. The optical clear adhesive film 100 includes a colloid layer 10, a first protective film 11, and a second protective film 12. The first protective film 11 and the second protective film 12 are attached to opposite sides of the colloid layer 10, respectively.

The first protective film 11 has a first body 110 and a first tearing part 111. A shape of the first body 110 is a rectangle. Specifically, the shape of the first body 110 is a rectangle. The first body 110 has a first side 1101. When the shape of the first body 110 is a rectangle, the first side 1101 is a shorter side of the first body 110. In other embodiments of the optical clear adhesive film, the first side 1101 may also be a longer side of the first body 110.

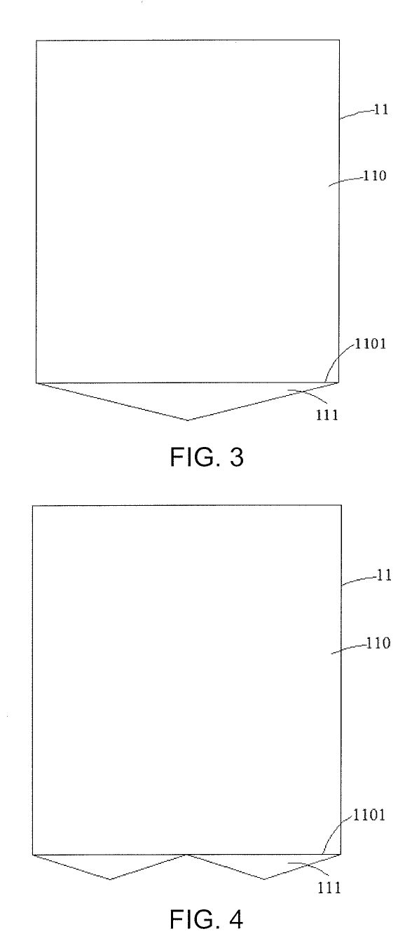

Refer to FIG. 2 and FIG. 3. FIG. 3 is a first schematic plan view of the first protective film of the optical clear adhesive film as illustrated in FIG. 2. The first tearing part 111 extends form the first side 1101. Specifically, the first tearing part 111 extends from an entire of the first side 1101. A number of the first tearing part 111 is at least one, and the first tearing part 111 is an axisymmetric shape. For example, a shape of the first tearing part 111 is any one of an isosceles triangle, an isosceles trapezoid, a semi-ellipse shape, a semicircle, and a rectangle. Specifically, the number of the first tearing part 111 is one, the shape of the first tearing part 111 is an isosceles triangle, a bottom side of the isosceles triangle overlaps with the first side 1101, and an angle of an apex angle of the isosceles triangle opposite the first side 1101 is greater than 60 degrees.

When the first protective film 11 needs to be removed from the colloid layer 10, an external force acts on the vertex angle of the isosceles triangle of the first tearing part 111, and because the first tearing part 111 is an isosceles triangle, a peeling force between the first protective film 11 and the colloid layer 10 is uniformly dispersed to various points at a starting position where the colloid layer 10 and the first protective film 11 are separated from each other. The starting position on the colloid layer 10 is a side of the colloid layer 10 near the first side 1101. Compared with the prior art, in an initial position where the colloid layer 10 and the first protective film 11 are separated from each other, the colloid layer 10 is in line contact with the first protective film 11, such that the colloidal layer 10 can be prevented from being pulled.

Refer to FIG. 4, which is a second schematic plan view of the first protective film of the optical clear adhesive film as illustrated in FIG. 2. The first protective film 11 as illustrated in FIG. 4 is substantially similar to the first protective film 11 as illustrated in FIG. 3, except that the number of the first tearing parts 111 is plural, and the first tearing parts 111 extends form an entire of the first side 1101. Specifically, the first tearing part 111 is an isosceles triangle, and the number of the first tearing parts 111 is two.

When it is necessary to tear the first protective film 11 from the colloid layer 10, an external force is required to act on the two first tearing parts 111. For example, when a body to which the external force is applied is a robot, a number of robots required is two.

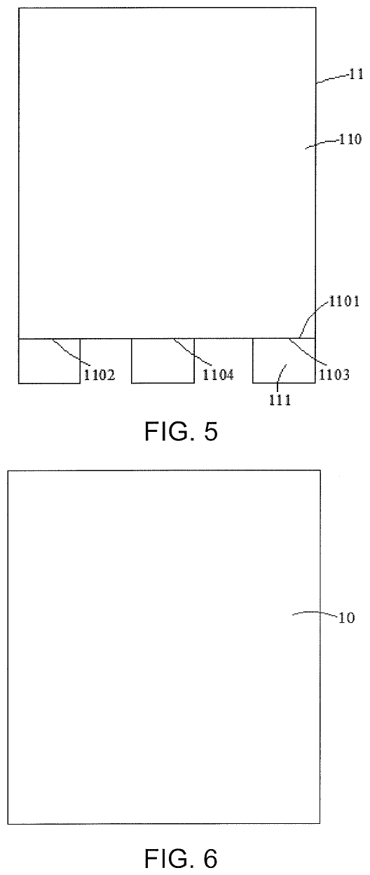

Refer to FIG. 5, which is a third plan view of the first protective film of the optical clear adhesive film as illustrated in FIG. 2. The first side 1101 has a plurality of line segments that are not connected to each other, and at least two of the line segments that are not connected to each other extend out of the first tearing part 111.

Specifically, the first side 1101 includes a first line segment 1102 and a second line segment 1103 at opposite ends of the first side 1101. The first side 1101 further includes a third line segment 1104 positioned in a middle of the first line segment 1102 and the second line segment 1103, and the first line segment 1102, the second line segment 1103, and the third line segment 1104 each extend out of one of the first tearing part 111.

When it is necessary to tear the first protective film 11 from the colloid layer 10, an external force acts on the first tearing part 111 extending from at least two line segments that are not connected to each other, such that one side of an entire of first protective film 11 is separated from the colloid layer 10, the starting position of the colloid layer 10 separated from the first protective film 11 is the side of the colloid layer 10 close to the first side 1101, that is, the starting position of the colloid layer 10 separated from the first protective film 11 is the side of the first side 1101 that the colloid layer 10 is close to, such that peeling force on a point and pull glue phenomenon are avoided when the separation of the colloid layer 10 is performed.

Refer to FIG. 6, which is a plan view of the colloid layer as illustrated in FIG. 2. The colloid layer 10 is rectangular. The colloid layer 10 is an optical clear adhesive. A thickness of the colloid layer 10 ranges between 0.5 microns and 30 microns. Further, the thickness of the colloid layer 10 ranges between 1 micron and 25 micrometers. Specifically, the thickness of the colloid layer 10 is 5 micrometers, 8 micrometers, or 10 micrometers. The thinner the thickness of the colloid layer 10, the more foldable or flexible display panel can be folded when the colloid layer 10 is applied to a foldable or flexible display panel. An orthographic projection of the colloid layer 10 on the first protective film 11 coincides with the first body 110, that is, a size of the colloid layer 10 is equal to a size of the first body 110 of the first protective film 11. An orthographic projection of the colloid layer 10 on the second protective film 12 coincides exactly with the second body 120.

Referring to FIG. 2, the second protective film 12 has a second body 120 and a second tearing part 121. The second body 120 has a second side 1201, and the second tearing part 121 extends from the second side 1201. The second tearing part 121 and the first tearing part 111 are positioned on a same side of the optical clear adhesive film 100. It can be understood that the second tearing part 121 and the first tearing part 111 may also be positioned on different sides of the optical clear adhesive film 100. For example, the second tearing part 121 and the first tearing part 111 are respectively positioned on opposite sides of the optical clear adhesive film 100. The second tearing part 121 extends from an entire of the second side 1201. A number of the second tearing part 121 is at least one, and a shape of the second tearing part 121 is any one of an isosceles triangle, an isosceles trapezoid, a semi-ellipse, a semi-circle, and a rectangle. The second tearing part 121 may also extend from a partial section of the second side 1201. The second tearing part 121 may be the same as the first tearing part 111, such that the first protective film 11 and the second protective film 12 are same, thereby simplifying an overall manufacturing process of the optical clear adhesive film 100. The first protective film 11 and the second protective film 12 each have a thickness ranging between 30 μm and 100 μm, the first protective film 11 may have a thickness of 50 μm, and the second protective film 12 may have a thickness of 75 μm. Materials of the first protective film 11 and the second protective film 12 are selected from polyethylene terephthalate or other materials.

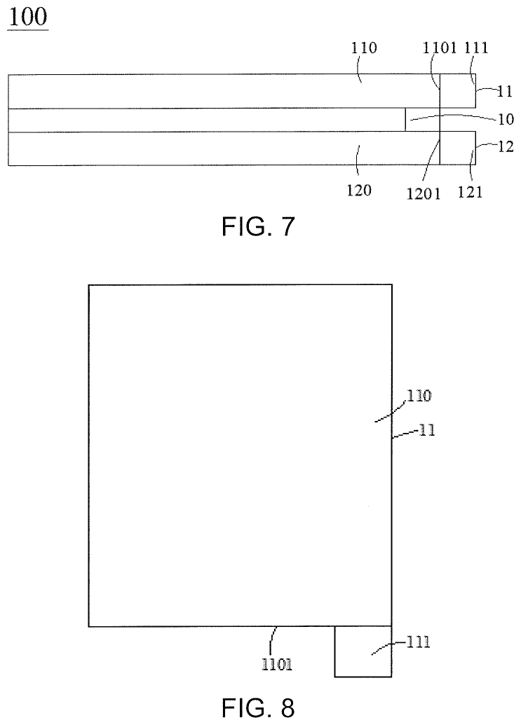

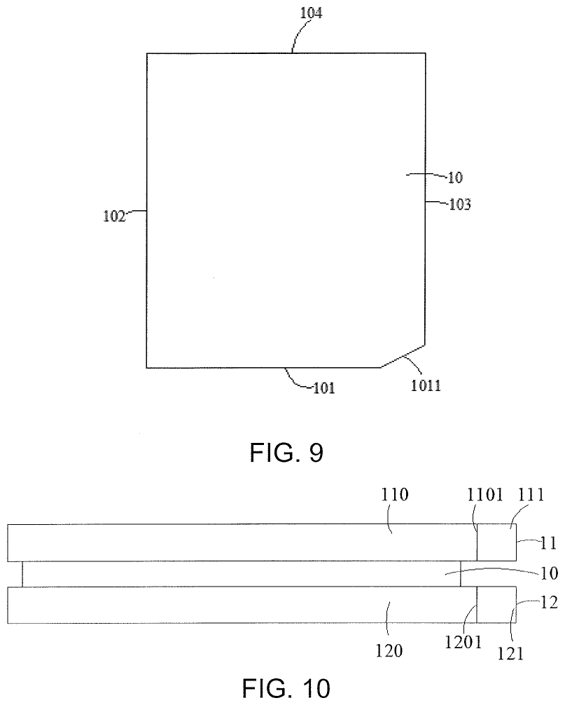

Refer to FIG. 7, FIG. 8, and FIG. 9. FIG. 7 is a side view of the optical clear adhesive film according a second embodiment of the present disclosure, FIG. 8 is a plan view of the first protective film of the optical clear adhesive film as illustrated in FIG. 7, and FIG. 9 is a schematic plan view of the colloidal layer of the optical clear adhesive film as illustrated in FIG. 7. The optical clear adhesive film 100 includes a colloid layer 10, a first protective film 11, and a second protective film 12. The first protective film 11 and the second protective film 12 are attached to opposite sides of the colloid layer 10, respectively.

The first protective film 11 has a first body 110 and a first tearing part 111. The first body 110 has a rectangular shape, and the first body 110 has a first side 1101. The first tearing part 111 extends from the first side 1101. Specifically, the first tearing part 111 extends from one end of the first side 1101. The shape of the first tearing part 111 may be a rectangle, a triangle, a semi-circle, or other shape. Specifically, the shape of the first tearing part 111 is a rectangle.

The shape of the colloid layer 10 is a rectangle having a connecting portion 1101, the connecting portion 1101 is positioned at a corner of the rectangle, and the connecting portion 1101 is disposed at a position where the colloid layer 10 is adjacent to the first tearing part 111. Specifically, the colloid layer 10 has a first side 101, a second side 102, a third side 103, a fourth side 104, and a connecting portion 1011 connecting the first side 101 and the third side 103. The first side 101 and the fourth side 104 are opposite straight lines, a length of the first side 101 is slightly less than a length of the fourth side 104, the second side 102 and the third side 103 are opposite straight lines, and a length of the third side 103 is slightly less than a length of the second side 102. The first side 101 is positioned at one end of the colloid layer 10 adjacent to the first tearing part 111, and the connecting portion 1011 is positioned at a side of the colloid layer 10 adjacent to the first tearing part 111. The connecting portion 1011 is a straight section. It can be understood that the connecting portion 1011 can also be an arc section.

The second protective film 12 has a second body 120 having a second side 1201 and a second tearing part 121 extending from the second side 1201. The second protective film 12 has the same structure as the first protective film 11 and will not be described in detail herein. The structure of the second protective film 12 and the shape of the first protective film 11 may also be different. For example, the first side 1101 and the second side 1201 are positioned on the same side of the optical clear adhesive film 100, and an end of the second side 1201 where the second tearing part 121 is positioned at is opposite to an end of the first side 1101 where the first tearing part 111 is positioned at. In addition, the second side 102 and the first side 101 of the colloid layer 10 are connected by the second connecting portion to avoid pull glue phenomenon when the second protective film 12 is peeled off from the colloid layer 10.

When the first protective film 11 needs to be removed from the colloid layer 10, the first protective film 11 is peeled off from the first side 1101 or peeled off from a corner. The connecting portion 1011 is disposed at a corner of the colloid layer 10 near the first tearing part 111. The starting position where the colloid layer 10 is separated from the first protective film 11 is a line contact, such that peeling force on a point and pull glue phenomenon of the colloid layer are avoided.

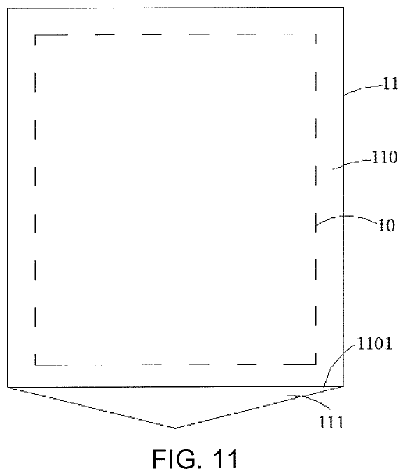

Refer to FIG. 10 and FIG. 11. FIG. 10 is a side view of an optical clear adhesive film according to a third embodiment of the present disclosure, and FIG. 11 is a plan view of the optical clear adhesive film as illustrated in FIG. 10. The optical clear adhesive film as illustrated in FIG. 10 is substantially similar to the optical clear adhesive film as illustrated in FIG. 2, except that a vertical projection of the colloid layer 10 on the first protective film 11 is positioned in the first body 110, a vertical projection of the colloid layer 10 on the second protective film 12 is positioned in the second body 120, and a vertical projection of the first body 10 on the second protective film 12 overlaps with the second body 120. That is, a size of the first body 110 of the first protective film 11 is greater than a size of the colloid layer. A size of the second body 120 of the second protective film 12 is greater than the size of the colloid layer 10, and the second body 120 and the first body 110 are the same size. Due to the fluidity of the colloid layer 10, the size of the first body 110 and the size of the second body 120 are greater than the size of the colloid layer 10 to prevent the colloid layer 10 from overflowing from the optical clear adhesive film 100.

The description of the above embodiments is only for helping to understand the technical solutions of the present disclosure and the core ideas thereof. Those of ordinary skill in the art should understand that they can still modify the technical solutions described in the foregoing embodiments, or some of the technologies. The features are equivalently substituted, and the modifications or substitutions do not detract from the scopes of the technical solutions of the embodiments of the present disclosure.

What is claimed is:

1. An optical clear adhesive film, comprising:
a colloid layer;
a first protective film; and
a second protective film, wherein the first protective film and the second protective film are attached to opposite sides of the colloid layer;
wherein the first protective film has a first body and a first tearing part, the first body has a first side, and the first tearing part extends from the first side; and
wherein a thickness of the colloid layer ranges between 0.5 micrometers and 30 micrometers.

2. The optical clear adhesive film according to claim 1, wherein the first tearing part extends from an entire of the first side.

3. The optical clear adhesive film according to claim 2, wherein a number of the first tearing part is at least one, and a shape of the first tearing part is any one of an isosceles triangle, an isosceles trapezoid, a semi-ellipse shape, a semicircle, and a rectangle.

4. The optical clear adhesive film according to claim 1, wherein the first side has a plurality of line segments that are not connected to each other, and at least two of the line segments that are not connected to each other extend out of the first tearing part.

5. The optical clear adhesive film according to claim 4, wherein the first side comprises a first line segment and a second line segment at opposite ends of the first side, the first side further comprises a third line segment positioned in a middle of the first line segment and the second line segment, and the first line segment, the second line segment, and the third line segment each extend out of one of the first tearing part.

6. The optical clear adhesive film according to claim 1, wherein the second protective film has a second body and a second tearing part, the second body has a second side, and the second tearing part extends from the second side.

7. The optical clear adhesive film according to claim 6, wherein the second tearing part and the first tearing part are positioned on a same side of the optical clear adhesive film.

8. The optical clear adhesive film according to claim 6, wherein a vertical projection of the colloid layer on the first protective film is positioned in the first body, a vertical projection of the colloid layer on the second protective film is positioned in the second body, and a vertical projection of the first body on the second protective film overlaps with the second body.

9. The optical clear adhesive film according to claim 1, wherein a thickness of the colloid layer ranges between 1 micron and 25 microns.

10. The optical clear adhesive film according to claim 1, wherein a shape of the colloid layer is a rectangle having a connecting portion, the connecting portion is positioned at a corner of the rectangle, and the connecting portion is disposed on the colloid layer adjacent to a position of the first tearing part.

11. An optical clear adhesive film, comprising:
a colloid layer;
a first protective film; and
a second protective film, wherein the first protective film and the second protective film are attached to opposite sides of the colloid layer;
wherein the first protective film has a first body and a first tearing part, the first body has a first side, and the first tearing part extends from the first side.

12. The optical clear adhesive film according to claim 11, wherein the first tearing part extends from an entire of the first side.

13. The optical clear adhesive film according to claim 12, wherein a number of the first tearing part is at least one, and a shape of the first tearing part is any one of an isosceles triangle, an isosceles trapezoid, a semi-ellipse shape, a semicircle, and a rectangle.

14. The optical clear adhesive film according to claim 11, wherein the first side has a plurality of line segments that are not connected to each other, and at least two of the line segments that are not connected to each other extend out of the first tearing part.

15. The optical clear adhesive film according to claim 14, wherein the first side comprises a first line segment and a second line segment at opposite ends of the first side, the first side further comprises a third line segment positioned in a middle of the first line segment and the second line segment, and the first line segment, the second line segment, and the third line segment each extend out of one of the first tearing part.

16. The optical clear adhesive film according to claim 11, wherein the second protective film has a second body and a second tearing part, the second body has a second side, and the second tearing part extends from the second side.

17. The optical clear adhesive film according to claim 16, wherein the second tearing part and the first tearing part are positioned on a same side of the optical clear adhesive film.

18. The optical clear adhesive film according to claim 16, wherein a vertical projection of the colloid layer on the first protective film is positioned in the first body, a vertical projection of the colloid layer on the second protective film is positioned in the second body, and a vertical projection of the first body on the second protective film overlaps with the second body.

19. The optical clear adhesive film according to claim 11, wherein a thickness of the colloid layer ranges between 1 micron and 25 microns.

20. The optical clear adhesive film according to claim 11, wherein a shape of the colloid layer is a rectangle having a connecting portion, the connecting portion is positioned at a corner of the rectangle, and the connecting portion is disposed on the colloid layer adjacent to a position of the first tearing part.
